(19) United States
(12) Patent Application Publication
(10) Pub. No.: US 2015/0160006 A1
(43) Pub. Date: Jun. 11, 2015

(54) DERIVATION OF SEA ICE THICKNESS USING ISOSTACY AND UPWARD LOOKING SONAR PROFILES

(71) Applicant: CONOCOPHILLIPS COMPANY, Houston, TX (US)

(72) Inventors: Khalid A. SOOFI, Katy, TX (US); Dom BERTA, Flower Mound, TX (US)

(21) Appl. No.: 14/564,479

(22) Filed: Dec. 9, 2014

Related U.S. Application Data
(60) Provisional application No. 61/914,565, filed on Dec. 11, 2013.

(51) Int. Cl. G01B 21/08; G01B 5/18; G01S 15/88; G01B 11/00; G01V 99/00

(52) U.S. Cl. CPC G01B 21/08; G01B 11/002; G01V 99/00; G01S 15/88; G01B 5/18

(57) ABSTRACT

A method for estimating a total thickness of sea ice floating in sea water having a sea water level includes obtaining a set of surface topographic data points of the sea ice representing elevation of those surface topographic data points with reference to a sea water level using a surface topography acquisition system, and estimating, using a processor, the total thickness of the sea ice above and below the sea water level using the elevation of each of the points.

### CROSS-REFERENCE TO RELATED APPLICATIONS

This application is a non-provisional application which claims benefit under 35 USC §119(e) to U.S. Provisional Applications Ser. No. 61/914,565 filed Dec. 11, 2013, entitled “DERIVATION OF SEA ICE THICKNESS USING ISOSTACY AND UPWARD LOOKING SONAR PROFILES,” which is incorporated herein in its entirety.

### FIELD OF THE INVENTION

This invention relates to apparatus and method for characterizing sea ice and, in particular, to estimating a thickness of the sea ice.

### BACKGROUND OF THE INVENTION

As land based hydrocarbon reservoirs become depleted, reserves in more remote and hostile locations of the earth are being explored. Many of these new locations are marine based and include cold regions such as the Arctic and Antarctic regions. These regions can be very cold especially in the winter time. Cold temperature can cause the formation of sea ice and ice floes, which is sea ice that drifts due to ocean currents and wind. It is noted that in many regions such as the North Atlantic and the Baltic, sea floes are traditionally a seasonal event, appearing in winter and vanishing in warmer seasons.

Ice floes can have dimensions that range from tens of meters to several kilometers and an associated mass. Drifting sea ice with such a large mass can pose significant problems to hydrocarbon production platforms in those regions subjected to ice floes. Accordingly, there is a need to accurately model ice floes in order to study them to increase understanding of their dynamics and ice load distributions, and further understand the forces they may impact on the production platforms.

### SUMMARY OF THE INVENTION

In one embodiment, a method for estimating a total thickness of sea ice floating in sea water having a sea water level is disclosed. The method includes obtaining a set of surface topographic data points of the sea ice representing elevation of those surface topographic data points with reference to a sea water level using a surface topography acquisition system, and estimating, using a processor, the total thickness of the sea ice above and below the sea water level using the elevation of each of the points.

### BRIEF DESCRIPTION OF THE DRAWINGS

The invention, together with further advantages thereof, may best be understood by reference to the following description taken in conjunction with the accompanying figures by way of example and not by way of limitation, in which:

FIG. 1 depicts aspects of generating a total thickness profile of sea ice that includes a surface profile and an undersea profile;

FIG. 2 depicts aspects of measuring the surface topography of the sea ice using small aperture radar; and

FIG. 3 is one example of a flow chart for a method for estimating a total thickness of sea ice floating in sea water having a sea water level.

### DETAILED DESCRIPTION OF THE INVENTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variation can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

Disclosed are method and apparatus for generating a total thickness profile of sea ice. The sea ice having a density that is less than the density of the sea water that it is in floats in the sea water and has a portion that is above the surface of the sea water and another portion that is below the surface of the sea water. The method and apparatus relate to generating a surface thickness profile, referred to as the surface profile, of the surface portion of the sea ice and an undersea thickness profile, referred to as the undersea profile, of the undersea portion of the sea ice. The surface profile and the undersea profile are then combined using a processor to generate the total thickness profile.

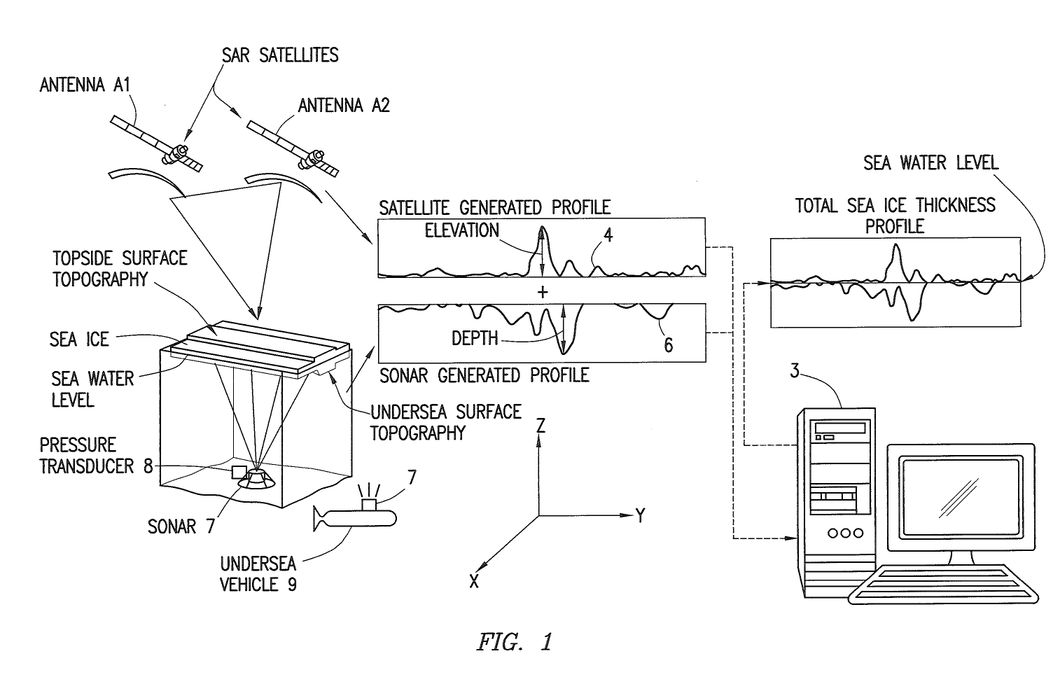

Referring now to FIG. 1, one embodiment of apparatus for generating the total thickness profile of sea ice is illustrated. In the embodiment of FIG. 1, a surface topography acquisition system (STAS) 2 is positioned above the sea ice and is configured to acquire surface data that can be processed by a processing system 3 to generate a surface profile 4 of the sea ice. The locations of the satellites are precisely known so that the data points representing the above-water surface of the sea ice are registered to corresponding specific locations in three dimensions. The locations may be represented by Cartesian coordinates, X-Y-Z, with the X-Y plane being the surface of the sea water. Other three dimensional coordinates may be used and converted to the Cartesian coordinates using known geometric relationships. The X, Y, and Z axes are illustrated in FIG. 1. The surface profile 4 relates to the height (i.e., Z-coordinate as illustrated in FIG. 1) of the sea ice above the surface of the sea water. In FIG. 1, the surface topography acquisition system 2 includes a first synthetic-aperture radar (SAR) satellite that is closely spaced to a second SAR satellite. Using a phase relationship between the data acquired by the first SAR satellite and the second SAR satellite and the geometry of the satellites and the sea ice, the topography of the sea ice can be determined as discussed in further detail below. Non-limiting embodiments of SAR satellites are ESA-ERS and ESA-ENVISAT of the European Space Agency. Alternatively, the surface data may be acquired using other airborne or orbiting surface topology acquisition systems. One example is LIDAR, which is a remote sensing technology that measures distance by illuminating a target with a laser and analyzing the reflected light.

Still referring to FIG. 1, an undersea topography acquisition system (UTAS) 5 is positioned below the surface of the sea water and is configured acquire undersea data that can be processed by the processing system 3 to generate an undersea profile 6 of the sea ice. In the embodiment of FIG. 1, the undersea topography acquisition system 5 includes an upward looking Sonar 7 tethered to the sea floor in a precisely known location. The upward looking Sonar 7 is configured to measure the undersea topography of the sea ice by emitting an acoustic pulse upward that is reflected by the underside of the sea ice and travels back to the Sonar 7. By measuring the time it takes for the pulse to return and knowing that the pulse makes a round trip, the distance from the Sonar 7 to the underside of the sea ice can be calculated using the speed of sound in the sea water. The depth of the sea ice is thus the depth of the Sonar 7 minus the distance from the Sonar 7 to the underside of the sea ice. Because the location of the UTAS 5 is precisely known, the data points representing the below-water surface of the sea ice are registered to corresponding specific locations in three dimensions. The locations may be represented by Cartesian coordinates, X-Y-Z, with the X-Y plane being the surface of the sea water. Other three dimensional coordinates may be used and converted to the Cartesian coordinates using known geometric relationships. The undersea profile 5 relates to the depth (i.e., Z-coordinate as illustrated in FIG. 1) of the sea ice below the surface of the sea water. In one or more embodiments, the depth represented by the Z-coordinate may be a negative number because Z=0 may represent the surface of the sea water with positive numbers representing heights of sea ice above the surface of the sea water. In one or more embodiments, the upward looking Sonar 7 is configured to emit four 300 kHz acoustic pulses every three minutes. With an aperture angle of 2° and a nominal depth of 50 meters (m), the sonar beam covers a footprint on the underside of the sea ice of radius 1.75 m. The UTAS 5 may also include a pressure transducer 8 configured to monitor the depth of the Sonar 7. One example of the UTAS 5 is the ES300 from Christian Michelsen Research of Bergen, Norway. As an alternative to the Sonar 7 being tethered to the sea floor, the Sonar 7 may be attached to an undersea vehicle 9, which may be manned or unmanned. The precise location of the undersea vehicle may be determined while it acquires topography data of the underside of the sea ice by use of an undersea navigation system such as an inertial guidance system or by use of an acoustic location system that includes acoustic beacons on the sea floor. Accordingly, the location of the undersea vehicle (e.g., in the X-Y plane) may be registered to the corresponding data as the vehicle acquires the data with the sonar providing the depth of the sea ice along the Z-axis.

In one or more embodiments, the total thickness of the sea ice may be estimated from the surface topography using an isostasy method. The isostasy method is based on the principle of buoyancy where the sea ice immersed in sea water is buoyed with a force equal to the weight of the displaced sea water. Hence, assuming approximately constant sea ice density, the volume of sea ice and associated depth necessary to support the amount of sea ice above the sea water level may be calculated. Assuming a complete isostatic compensation (i.e., free floating ice), the total thickness H of the sea ice may be calculated using Airy's formula:

$$H = {e}_{i} \frac{{ρ}_{w}}{{ρ}_{w} - {ρ}_{i}}$$

where eᵢ is the elevation of the sea ice above the sea water level, ρ_{w} is the average density of the sea water, and ρᵢ is the average density of the sea ice. Assuming ρ_{w}=1.025×10³ kg/m³ and pᵢ=0.91×10³ kg/m³, variations in ice thickness in excess of 10 meters may be detected in one or more embodiments.

As discussed above, the STAS 2 obtains data points delineating the surface topography of the sea ice above the sea water level and the UTAS 5 obtains data points delineating the topography of the sea ice surface below the sea water level. The data points are three-dimensional coordinates, which may include x-y-z coordinates where the x-y plane is the plane of the sea water level and the z coordinate represents elevation above the sea water level or depth below the sea water level. The processing system 3 processes these data points to provide a total thickness of the sea ice from below the sea water level to above the sea water level. In one or more embodiments, the elevation of one STAS data point is added to the depth of one UTAS data point when those data points have the same x-y coordinates in order to calculate the total thickness of the sea ice at that x-y coordinate. In some situations an STAS data point may not line up exactly with a UTAS data point in the x-y plane. In these situations, the elevation and the depth may be added as long as the x-y coordinate of the STAS data point and the UTAS data point are within a selected range or distance of each other such as being within a distance of each other that is less than half the distance to the next adjacent STAS or UTAS data point. Alternatively, an elevation of a STAS data point and/or a depth of a UTAS data point may be interpolated from adjacent data points in order get the x-y values of elevation and depth to line up with each other.

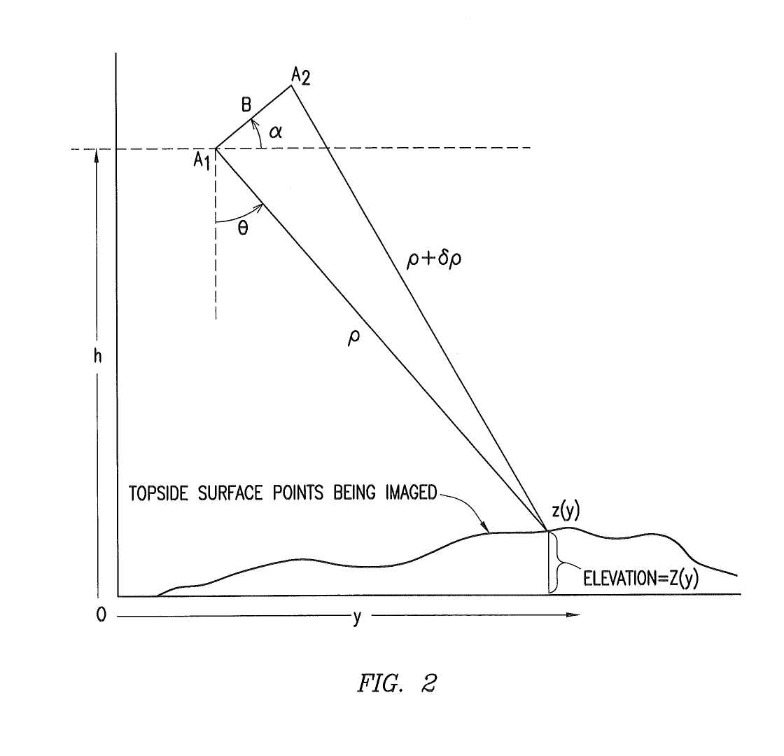

Synthetic Aperture Radar interferometric processing to derive the topography of the sea ice is now discussed in more detail referring to FIG. 2. In FIGS. 2, A1 and A2 are two radar antennas on the SAR satellites that simultaneously view the same surface of the sea ice and are separated by a baseline vector B with length B and angle α with respect to a horizontal reference. Antenna A1 is located at height h above the level of the sea water. The distance between antenna A1 and the point to be imaged of the surface of the sea ice is the range ρ, while ρ+δρ is the distance between antenna A2 and the same point on the surface of the sea ice. The goal is to determine the elevation z at points on the surface of the sea ice. The topography or elevation z(y) can be inferred from a phase measurement to a precision of several meters and is calculated using equation (1) where θ is the look angel of the radar antenna A1 and is the known height of antenna A1.

z(y)=h−ρcos θ (1)

A SAR interferogram, viewed as a fringe pattern, shows the relative difference between phases of the two images obtained by A1 and A2. The phase difference φ depends on the geometry of the tracks of the two antennas and the image point and thus is proportional to the difference in path times (or delays) from the two antennas imaging the same point and is given by equation (2) where λ, is the wavelength of the radar waves.

φ=4π(ρ−(ρ+δρ))/λ (2)

To determine z, the interferometric processing steps that are generally followed are (a) selection of a suitable pair of SAR images, (b) geometric registration of the images, (c) interferogram generation based on the two images, (d) phase unwrapping of the interferogram, and (e) extraction of elevations from the phases.

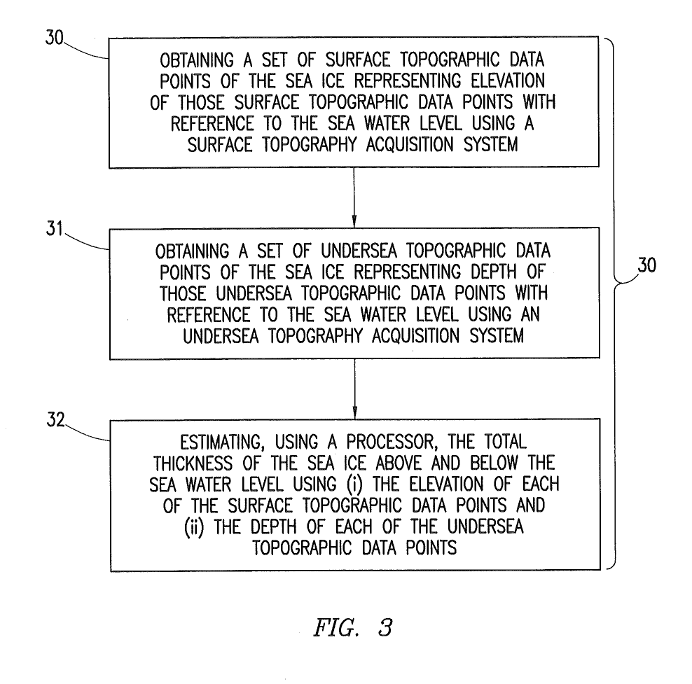

FIG. 3 is a flow chart for one example of a method 30 for estimating a total thickness of sea ice floating in sea water having a sea water level. Block 31 calls for obtaining a set of surface topographic data points of the sea ice representing elevation of those surface topographic data points with reference to the sea water level using a surface topography acquisition system. The surface topography acquisition system may include SAR or LIDAR in airborne or orbital applications in non-limiting embodiments. Block 32 calls for obtaining a set of undersea topographic data points of the sea ice representing depth of those undersea topographic data points with reference to the sea water level using an undersea topography acquisition system. Block 33 calls for estimating, using a processor, the total thickness of the sea ice above and below the sea water level using (i) the elevation of each of the surface topographic data points and (ii) the depth of each of the undersea topographic data points. The method 30 may also include calculating the total thickness of the sea ice using just the (i) the elevation of each of the surface topographic data points by using an isostasy method based on the buoyancy of the sea ice. The method 30 may also include cross-checking or comparing (a) the estimated total thickness of the sea ice determined using the isostasy method to (b) the estimated total thickness of the sea ice using both the surface topographic data points and the undersea topographic data points. The cross-checking may provide a level of quality assurance to the estimated total thickness. In one or more embodiments, the cross-checking includes providing an alert to a user, using a user interface such as a display, when a difference between the estimated total thickness from (a) and the estimated total thickness from (b) exceeds a selected threshold value. The threshold value is selected to provide a desired level of quality assurance. The method 30 may also include displaying the total thickness of sea ice at one or more points to a user using a display. The total thickness of the sea ice may be displayed as a cross-sectional profile along a line of points selected by the user. The line can be a straight line or a curved line.

In support of the teachings herein, various analysis components may be used, including a digital and/or an analog system. For example, the processing system 3 may include digital and/or analog systems. The system may have components such as a processor, storage media, memory, input, output, communications link (wired, wireless, optical or other), user interfaces, display, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

What is claimed is:

1. A method for estimating a total thickness of sea ice floating in sea water having a sea water level, the method comprising:
obtaining a set of surface topographic data points of the sea ice representing elevation of those surface topographic data points with reference to the sea water level using a surface topography acquisition system; and
estimating, using a processor, the total thickness of the sea ice above and below the sea water level using the elevation of each of the points.

2. The method according to claim 1, wherein the surface topographic acquisition system comprises at least one of an airborne or orbit based synthetic aperture radar system or LIDAR system.

3. The method according to claim 1, wherein estimating comprises calculating the total thickness of the sea ice using an isostasy method to process the set of surface topographic data points.

4. The method according to claim 3, wherein estimating further comprises solving:
$$H = {e}_{i} \frac{{ρ}_{w}}{{ρ}_{w} - {ρ}_{i}}$$
where H is the total thickness of the sea ice, eᵢ is the elevation of the sea ice above the sea water level, ρ_{w} is the average density of the sea water, and ρᵢ is the average density of the sea ice.

5. The method according to claim 1, further comprising:
obtaining a set of undersea topographic data points of the sea ice representing depth of those undersea topographic data points with reference to the sea water level using an undersea topography acquisition system; and
wherein estimating further comprises using the depth of each of the undersea topographic data points to estimate the total thickness of the sea ice.

6. The method according to claim 5, wherein the surface topographic data points and the undersea data points comprise three-dimensional coordinates x, y, z with the x-y plane being in the plane of the sea water level.

7. The method according to claim 6, wherein estimating further comprises summing the elevation of one surface topographic data point and the depth of one corresponding undersea topographic data point when the x and y coordinates of those data points are within a selected distance from each other.

8. The method according to claim 7, wherein the selected distance is less than one-half the distance to a next adjacent surface or undersea topographic data point in the x-y plane.

9. The method according to claim 6, wherein estimating further comprises at least one of (a) interpolating values between adjacent surface topographic data points to provide an interpolated surface elevation value and (b) interpolating values between adjacent undersea topographic data points to provide an interpolated depth value in order to provide a surface topographic elevation value and an undersea topographic depth value having the same x-y coordinates.

10. The method according to claim 9, wherein estimating further comprises summing A and B for the same x-y coordinates where A is one of a surface elevation and an interpolated surface elevation value and B is one of an undersea depth and an interpolated undersea depth value.

11. The method according to claim 5, wherein the undersea topography acquisition system comprises an upward looking sonar configured to measure a distance between the sonar and the underside surface of the sea ice below the sea water level.

12. The method according to claim 11, wherein the undersea topography acquisition system comprises a pressure sensor configured to sense a depth of the sonar.

13. The method according to claim 11, wherein the undersea topography acquisition system is at least one of tethered to a sea floor beneath the sea ice and disposed on an undersea vehicle.

14. The method according to claim 1, further comprising displaying the total thickness of sea ice at one or more points to a user using a display.

15. The method according to claim 14, wherein displaying comprises displaying a cross-sectional profile of the total thickness of the sea ice along a line of points selected by the user.

16. The method according to claim 1, wherein estimating comprises (i) estimating a first total thickness using the elevations of the surface topographic data points and an isostasy method and (ii) estimating a second total thickness using the elevations of the surface topographic data points and depths of undersea topographic data points.

17. The method according to claim 16, cross-checking the first estimated total thickness against the second estimated total thickness.

18. The method according to claim 17, wherein cross-checking comprises providing an alert to a user using a user-interface when a difference between the first estimated total thickness and the second estimated total thickness exceeds a selected threshold value.
